(19) United States
(12) Patent Application Publication
(10) Pub. No.: US 2019/0058518 A1
(43) Pub. Date: Feb. 21, 2019

(54) BEAM BASED COMMUNICATION DEVICE AND ACCESS POINT

(71) Applicant: NOKIA SOLUTIONS AND NETWORKS OY, Espoo (FI)

(72) Inventors: Timo Koskela, Oulu (FI); Samuli Heikki Turtinen, Ii (FI); Vinh Van Phan, Oulu (FI); Sami-Jukka Hakola, Kempele (FI); Juho Mikko Oskari Pirskanen, Kangasala (FI)

(21) Appl. No.: 16/087,573

(22) PCT Filed: Mar. 24, 2016
(86) PCT No.: PCT/EP2016/056576

§ 371 Date: Sep. 24, 2018

(51) Int. Cl. H04B 7/06; H04W 76/28; H04W 72/04; H04B 7/0408

(52) U.S. Cl. CPC H04B 7/0695; H04B 7/0408; H04W 72/046; H04W 76/28

(57) ABSTRACT

A method comprises determining at a communication device for a set of beams provided by one or more access points if a respective beam satisfies a threshold. A set of beams comprises one or more communication beams and each access point provides a plurality of communication beams. In dependence on the determining, an indication is be transmitted to at least one access point.

### FIELD

This disclosure relates to wireless communication and more particularly to wireless communication via antenna beams provided by access points for communication with user equipment of a communication system.

### BACKGROUND

A communication system can be seen as a facility that enables communication between two or more nodes such as fixed or mobile communication devices, access points such as base stations, servers, machine-type devices and so on. A communication system and compatible communicating entities typically operate in accordance with a given standard or specification which sets out what the various entities associated with the system are permitted to do and how that should be achieved. For example, the standards, specifications and related protocols can define the manner how communications between communication devices and the access points shall be arranged, how various aspects of the communications shall be provided and how the equipment shall be configured.

Signals can be carried on wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells, and hence the wireless systems are often referred to as cellular systems. An access point such as a base station can provide one or more cells, there being various different types of base stations and cells. In modern radio communication networks, such as the Long Term Evolution (LTE) or the LTE-Advanced (LTE-A) of the 3rd Generation Partnership Project (3GPP), common base stations (often called as Node B; NB or enhanced Node B; eNB) are used.

A user can access the communication system and communicate with other users by means of an appropriate communication device or terminal. Communication apparatus of a user is often referred to as a user equipment (UE). Typically a communication device is used for enabling receiving and transmission of communications such as speech and data. A communication device is provided with an appropriate signal receiving and transmitting arrangement for enabling communications.

Some networks use or have been proposed which use beamforming techniques. For example the proposed 5G radio access technology and LTE-A (Long term evolution-advanced) evolution have proposed using beam forming techniques. The so-called 5G system may use frequencies from 400 MHz to 100 GHz. Beamforming is considered to be desirable in enabling the use of the higher frequency bands due to coverage issues.

### SUMMARY

According to one aspect, there is provided a method comprising: determining at a communication device for a set of beams provided by one or more access points if a respective beam satisfies a criteria, wherein said set of beams comprises one or more communication beams and each access point provides a plurality of communication beams; and in dependence on said determining, causing an indication to be transmitted to at least one access point.

The set of beams may comprise at least two beams.

The set of beams may comprise at least one beam provided by a first access point and at least one beam provided by a second access point.

At least two of said beams in said set may have a respective different criteria.

All of said beams in said set may have a same criteria.

The method may comprise receiving information on the or each criteria from the or respective access point.

The determining may be performed when said communication device is in a discontinuous reception mode.

The indication may comprise a single indication for said set of beams.

The indication may comprise a single bit.

The indication may comprise an indication indicating that at least one of said beams of said set satisfies a respective criteria.

The indication may comprise an indication indicating that all of said beams of said set satisfy a respective criteria.

The causing of said indication to be transmitted may be carried out with a defined periodicity.

The method may comprise when, in dependence on said determining that said indication is not be transmitted, causing a scheduling request to be transmitted to at least one access point.

The method may comprise only causing said scheduling request to be transmitted if at least one condition is satisfied.

The at least one condition may be related to said at least one criteria.

The indication may comprise a scheduling request.

The indication may be transmitted in an uplink sweep block.

The indication may be transmitted in an uplink control symbol.

The method may comprise, after causing said transmission of said indication, receiving a request from an access point for information on one or more beams and in response thereto, providing said requested information on said one or more beams.

An apparatus may be provided to perform any of the above methods. The apparatus may be provided in a communication device.

According to another aspect, there is provided method comprising: providing a plurality of communication beams, one or more of said communication beams being a set for communication with a communication device; and receiving an indication from said communication device, said indication being dependent on whether if a respective beam satisfies a criteria at the communication device.

The set of beams may comprise at least two beams.

At least two of said beams in said set may have a respective different criteria.

All of said beams in said set may have a same criteria.

The method may comprise causing transmitting of information on the or each criteria to the communication device.

The indication may be received when said communication device is in a discontinuous reception mode.

The indication may comprise a single indication for said set of beams.

The indication may comprise a single bit.

The indication may comprise an indication indicating that at least one of said beams of said set satisfies a respective criteria.

The indication may comprise an indication indicating that all of said beams of said set satisfy a respective criteria.

The method may comprise receiving said indication with a defined periodicity.

The method may comprise receiving a scheduling request.

The method may comprise only receiving said scheduling request if at least one condition is satisfied.

The at least one condition may be related to said at least one criteria.

The indication may comprise a scheduling request.

The indication may be received in an uplink sweep block.

The indication may be received in an uplink control symbol.

The method may comprise, after receiving said indication, cause transmission to said communication device of a request for information on one or more beams and in response thereto, receive from said communication device said requested information on said one or more beams.

An apparatus may be provided to perform any of the above methods. The apparatus may be provided in an access point.

According to another aspect there is provided a computer program comprising computer executable code which when run may cause any one of the preceding methods to be performed.

According to another aspect there is provided a computer-readable non-transitory storage medium carrying one or more sequences of instructions which when run cause any one of the above methods to be performed.

According to another aspect, there is provide an apparatus in a communication device comprising at least one processor and at least one memory including computer code for one or more programs, the at least one memory and the computer code configured, with the at least one processor, to cause the apparatus at least to: determine at a communication device for a set of beams provided by one or more access points if a respective beam satisfies a criteria, wherein said set of beams comprises one or more communication beams and each access point provides a plurality of communication beams; and in dependence on said determining, cause an indication to be transmitted to at least one access point.

The set of beams may comprise at least two beams.

The set of beams may comprise at least one beam provided by a first access point and at least one beam provided by a second access point.

At least two of said beams in said set may have a respective different criteria.

All of said beams in said set may have a same criteria.

The at least one memory and the computer code may be configured, with the at least one processor, to cause the apparatus to receive information on the or each criteria from the or respective access point.

The at least one memory and the computer code may be configured, with the at least one processor, to cause the apparatus to perform said determining when said communication device is in a discontinuous reception mode.

The indication may comprise a single indication for said set of beams.

The indication may comprise a single bit.

The indication may comprise an indication indicating that at least one of said beams of said set satisfies a respective criteria.

The indication may comprise an indication indicating that all of said beams of said set satisfy a respective criteria.

The at least one memory and the computer code may be configured, with the at least one processor, to cause the apparatus to cause said indication to be transmitted is carried out with a defined periodicity.

The at least one memory and the computer code may be configured, with the at least one processor, to cause the apparatus, when, in dependence on said determining that said indication is not be transmitted, cause a scheduling request to be transmitted to at least one access point.

The at least one memory and the computer code may be configured, with the at least one processor, to cause the apparatus only to cause said scheduling request to be transmitted if at least one condition is satisfied.

The at least one condition may be related to said at least one criteria.

The indication may comprise a scheduling request.

The at least one memory and the computer code may be configured, with the at least one processor, to cause the apparatus to cause the indication to be transmitted in an uplink sweep block.

The at least one memory and the computer code may be configured, with the at least one processor, to cause the apparatus to cause the said indication to be transmitted in an uplink control symbol.

The at least one memory and the computer code may be configured, with the at least one processor, to cause the apparatus, after causing said transmission of said indication, to receive a request from an access point for information on one or more beams and in response thereto, provide said requested information on said one or more beams.

Any of the above apparatus may be provided in a communication device.

According to another aspect, there is provided an apparatus in an access point comprising at least one processor and at least one memory including computer code for one or more programs, the at least one memory and the computer code configured, with the at least one processor, to cause the apparatus at least to: provide a plurality of communication beams, one or more of said communication beams being a set for communication with a communication device; and receive an indication from said communication device, said indication being dependent on whether if a respective beam satisfies a criteria at the communication device.

The set of beams may comprise at least two beams.

At least two of said beams in said set may have a respective different criteria.

All of said beams in said set may have a same criteria.

The at least one memory and the computer code may be configured, with the at least one processor, to cause the apparatus to transmit of information on the or each criteria to the communication device.

The indication may be received when said communication device is in a discontinuous reception mode.

The indication may comprise a single indication for said set of beams.

The indication may comprise a single bit.

The indication may comprise an indication indicating that at least one of said beams of said set satisfies a respective criteria.

The indication may comprise an indication indicating that all of said beams of said set satisfy a respective criteria.

The at least one memory and the computer code may be configured, with the at least one processor, to cause the apparatus to receive said indication with a defined periodicity.

The at least one memory and the computer code may be configured, with the at least one processor, to cause the apparatus to receive a scheduling request.

The at least one memory and the computer code may be configured, with the at least one processor, to cause the apparatus to only receive said scheduling request if at least one condition is satisfied.

The at least one condition may be related to said at least one criteria.

The indication may comprise a scheduling request.

The indication may be received in an uplink sweep block.

The indication may be received in an uplink control symbol.

The at least one memory and the computer code may be configured, with the at least one processor, to cause the apparatus, after receiving said indication, to cause transmission to said communication device of a request for information on one or more beams and in response thereto, to receive from said communication device said requested information on said one or more beams.

According to another aspect, there is provided an apparatus comprising: means for determining at a communication device for a set of beams provided by one or more access points if a respective beam satisfies a criteria, wherein said set of beams comprises one or more communication beams and each access point provides a plurality of communication beams; and means for causing, in dependence on said determining, an indication to be transmitted to at least one access point.

The set of beams may comprise at least two beams.

The set of beams may comprise at least one beam provided by a first access point and at least one beam provided by a second access point.

At least two of said beams in said set may have a respective different criteria.

All of said beams in said set may have a same criteria.

The apparatus may comprise means for receiving information on the or each criteria from the or respective access point.

The means for determining may be for determining when said communication device is in a discontinuous reception mode.

The indication may comprise a single indication for said set of beams.

The indication may comprise a single bit.

The indication may comprise an indication indicating that at least one of said beams of said set satisfies a respective criteria.

The indication may comprise an indication indicating that all of said beams of said set satisfy a respective criteria.

The means for causing said indication to be transmitted may be for transmitting said indication with a defined periodicity.

The apparatus may comprise means for causing, when, in dependence on said determining that said indication is not be transmitted, a scheduling request to be transmitted to at least one access point.

The means for causing said scheduling request to be transmitted may be for causing said scheduling request to be transmitted if at least one condition is satisfied.

The at least one condition may be related to said at least one criteria.

The indication may comprise a scheduling request.

The indication may be transmitted in an uplink sweep block.

The indication may be transmitted in an uplink control symbol.

The apparatus may comprise means for receiving a request, after causing said transmission of said indication, from an access point for information on one or more beams and in response thereto and means for providing said requested information on said one or more beams.

According to another aspect, there is provided an apparatus comprising: means for providing a plurality of communication beams, one or more of said communication beams being a set for communication with a communication device; and means for receiving an indication from said communication device, said indication being dependent on whether if a respective beam satisfies a criteria at the communication device.

The set of beams may comprise at least two beams.

At least two of said beams in said set may have a respective different criteria.

All of said beams in said set may have a same criteria.

The apparatus may comprise means for transmitting information on the or each criteria to the communication device.

The indication may be received when said communication device is in a discontinuous reception mode.

The indication may comprise a single indication for said set of beams.

The indication may comprise a single bit.

The indication may comprise an indication indicating that at least one of said beams of said set satisfies a respective criteria.

The indication may comprise an indication indicating that all of said beams of said set satisfy a respective criteria.

The means for receiving may be for receiving said indication with a defined periodicity.

The means for receiving may be for receiving a scheduling request.

The means for receiving may be for only receiving said scheduling request if at least one condition is satisfied.

The at least one condition may be related to said at least one criteria.

The indication may comprise a scheduling request.

The indication may be received in an uplink sweep block.

The indication may be received in an uplink control symbol.

The apparatus may comprise means for causing transmission, after receiving said indication, to said communication device of a request for information on one or more beams and said receiving means may be for receiving in response thereto, from said communication device said requested information on said one or more beams.

A device for a communication system may comprise the apparatus according to the above elements.

A computer program comprising program code means adapted to perform the herein described methods may also be provided.

In accordance with further embodiments apparatus and/or computer program product that can be embodied on a computer readable medium for providing at least one of the above methods is provided.

It should be appreciated that any feature of any aspect may be combined with any other feature of any other aspect.

### DESCRIPTION OF DRAWINGS

Embodiments will now be described in further detail, by way of example only, with reference to the following examples and accompanying drawings, in which:

FIG. 1 shows a schematic diagram of a control apparatus according to some embodiments;

FIG. 2 shows a schematic presentation of a possible communication device;

FIG. 3 shows a schematic diagram of an access point with a plurality of beams and a communication device;

FIG. 4 schematically shows sweep blocks;

FIG. 5 shows a flowchart of a method of an embodiment;

FIG. 6 schematically shows two access points serving the same UE;

FIG. 7 shows a flowchart where a beam indication is received by an access point;

FIG. 8 shows one example of a report from a UE.

### DETAILED DESCRIPTION OF PREFERRED EMBODIMENTS

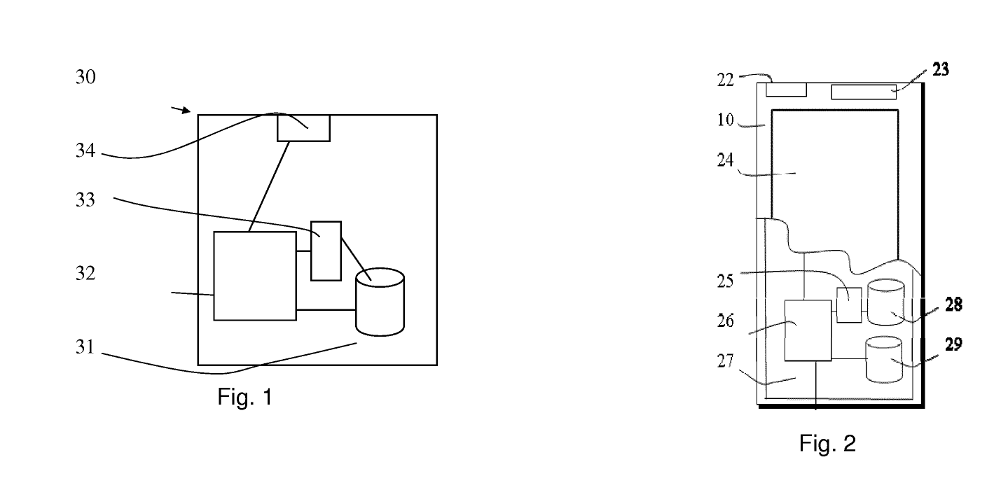

In the following certain exemplifying embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1 to 2 to assist in understanding the technology underlying the described examples.

A communication device 10 or terminal can be provided wireless access via base stations or similar wireless transmitter and/or receiver nodes providing access points of a radio access system.

Each of the access points may provide at least one antenna beam directed in the direction of the communication device 10. The antenna beam can be provided by appropriate elements of antenna arrays of the access points.

For example, access links between the access points (AP) and a user equipment (UE) can be provided by active antenna arrays. Such arrays can dynamically form and steer narrow transmission/reception beams and thus serve UEs and track their positions. This is known as UE-specific beamforming. The active antenna arrays can be used both at the AP and at the UE to further enhance the beamforming potential.

In other embodiments, the access point may provide a fixed beam pattern.

Some embodiments may have at least one access point providing a fixed beam pattern and at least one access point providing an active antenna array.

More than one beam can be provided by each access point and/or antenna array.

Access points and hence communications there through are typically controlled by at least one appropriate controller apparatus so as to enable operation thereof and management of mobile communication devices in communication therewith. FIG. 1 shows an example of a control apparatus for a node, for example to be integrated with, coupled to and/or otherwise for controlling any of the access points. The control apparatus 30 can be arranged to provide control on communications via antenna beams by the access points and on operations such as handovers between the access points. For this purpose the control apparatus comprises at least one memory 31, at least one data processing unit 32, 33 and an input/output interface 34. Via the interface the control apparatus can be coupled to relevant other components of the access point. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions may be distributed between several control units. In some embodiments, each base station can comprise a control apparatus. In alternative embodiments, two or more base stations may share a control apparatus.

Access points and associated controllers may communicate with each other via fixed line connection and/or air interface. The logical connection between the base station nodes can be provided for example by an X2 interface. This interface can be used for example for coordination of operation of the stations.

The communication device or user equipment (UE) 10 may comprise any suitable device capable of at least receiving wireless communication of data. For example, the device can be handheld data processing device equipped with radio receiver, data processing and user interface apparatus. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with wireless connectivity, jewellery and so on, universal serial bus (USB) sticks with wireless capabilities, modem data cards, machine type devices or any combinations of these or the like.

FIG. 2 shows a schematic, partially sectioned view of a possible communication device. More particularly, a handheld or otherwise mobile communication device (or user equipment UE) 10 is shown. A mobile communication device is provided with wireless communication capabilities and appropriate electronic control apparatus for enabling operation thereof. Thus the mobile device 10 is shown being provided with at least one data processing entity 26, for example a central processing unit and/or a core processor, at least one memory 28 and other possible components such as additional processors 25 and memories 29 for use in software and hardware aided execution of tasks it is designed to perform. The data processing, storage and other relevant control apparatus can be provided on an appropriate circuit board 27 and/or in chipsets. Data processing and memory functions provided by the control apparatus of the mobile device are configured to cause control and signalling operations in accordance with certain embodiments of the present invention as described later in this description. A user may control the operation of the mobile device by means of a suitable user interface such as touch sensitive display screen or pad 24 and/or a key pad, one of more actuator buttons 22, voice commands, combinations of these or the like. A speaker and a microphone are also typically provided. Furthermore, a mobile communication device may comprise appropriate connectors (either wired or wireless) to other devices and/or for connecting external accessories, for example hands-free equipment, thereto.

The mobile device may communicate wirelessly via appropriate apparatus for receiving and transmitting signals. FIG. 2 shows schematically a radio block 23 connected to the control apparatus of the device. The radio block can comprise a radio part and associated antenna arrangement. The antenna arrangement may be arranged internally or externally to the mobile device. The antenna arrangement may comprise elements capable of beamforming operations.

Some embodiments relate to mobile communication networks which beamforming techniques. For example the proposed 5G radio access technology and LTE-A (Long term evolution—advanced) evolution have proposed using beam forming techniques. It should be appreciated that other embodiments may be used with any other communication system which uses beamforming. For example some wireless area networks may use beamforming.

The so-called 5G system may use frequencies from 400 MHz to 100 GHz. Beamforming is considered to be desirable in enabling the use of the higher frequency bands due to coverage issues.

Some transceivers may use analogue beamforming, which may mean a limited number of concurrent beams as this is dependent on the number of antenna ports. It should be appreciated that other embodiments may be used with digital beamforming transceiver architecture or so-called hybrid transceiver architecture which use a hybrid of digital baseband processing (such as MIMO Multiple Input Multiple Output and /or digital precoding) and analogue beamforming.

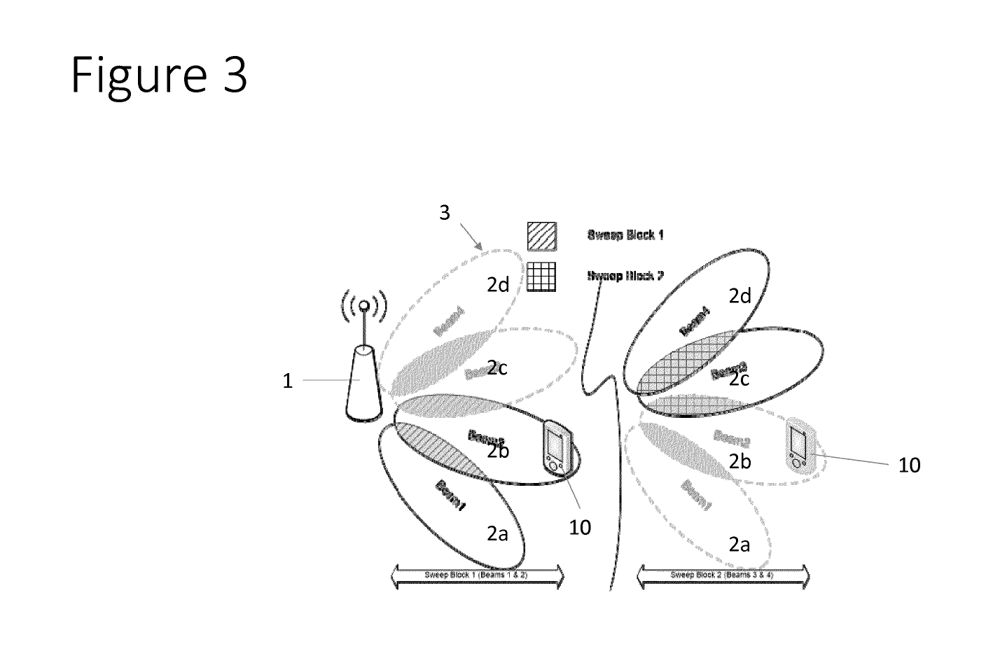

Reference is made to FIG. 3 which shows an access point 1. The access point may be a base station. In some standards, such as 5G, the access point may be referred to an eNB (evolved Node B). The access point has a cell coverage area generally denoted by the reference numeral 3. The cell coverage area is covered by beams defined by the access node. In the example shown in FIG. 3, only four beams are shown for simplicity (in 5G it is assumed the number of beams may vary from tens to hundreds per access point). These are beam 1, beam 2, beam 3 and beam 4. It should be appreciated that in different embodiments, more or less than four beams may be provided. In some embodiments, the number of beams provided may vary over time.

To enable system access, periodical transmission of system information may be required per direction where one or more beams cover a specific area of a cell. The corresponding directions may need to be covered to provide resources for system access. When an access point covers a specific area with set of beams during a time interval (such as symbol time or two symbol times) it is called a sweep block. FIG. 3 illustrates the concept of sweep blocks: For sweep block 1 the analogue beams 1 and 2 are active and for sweep block 2 the beams 3 and 4 are active. To schematically illustrate the sweep blocks, the four beams, for sweep block 1, show the first and second beams as active and the third and fourth beams as inactive with respect to the first sweep. The four beams are then shown for sweep block 2 with the first and second beams inactive and the third and fourth beams as inactive with respect to the second sweep. Each beam is shown twice, once for sweep block 1 and once for sweep block 2. It should be appreciated, that this is for illustrative purposes and in practice the position of the beams with respect to the access node is as represented for sweep block 1.

Although FIG. 3 illustrates that adjacent beams are active during a respective sweep block it should be understood that the set of beams may be any one or more of the available beams. For example sweep block 1 could be such that the beams 1 and 3 are active and for sweep block 2 the beams 2 and 4 are active.

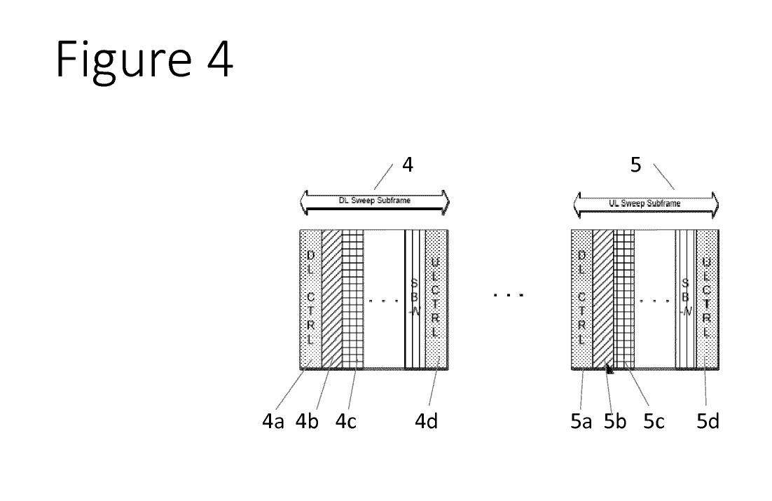

Reference is made to FIG. 4 which illustrates the sweep blocks in a downlink sub frame 4 (each block may take one or more symbols) and the corresponding uplink sub frame 5. The downlink sub frame has a first field 4a for downlink control, a second field 4b for the sweep block 1, a third field 4c for the sweep block 2, n other fields and a final field 4d for uplink control. The uplink sub frame 5 has a first field 5a for downlink control, a second field 5b for the sweep block 1, a third field 5c for the sweep block 2, n other fields and a final field 5d for uplink control. During the downlink sub frame and during each sweep block the specific beams are active on DL (downlink) direction (access point transmits). For example during the timeslot associated with the second field, the access point will transmit on beams 1 and 2 of sweep block 1 and during the timeslot associated with the third field, the access point will transmit on the beams 3 and 4 of sweep block 2. Likewise during the UL sub frame, and during the specific UL (uplink) sweep block the beams are active in the UL direction (access point receives). For example during the timeslot associated with the second field, the access point will receive on beams 1 and 2 of sweep block 1 and during the timeslot associated with the third field, the access point will receive on the beams 3 and 4 of sweep block 2.

These sweep blocks are assumed to be periodical so that for example during the DL sub frame, the access point may transmit for respective sweep blocks information such as broadcast/cell information/initial access information (covering specific direction/directions on each sweep block). There may be corresponding UL sweep blocks during the UL sub frame which cover the cell area in the uplink direction. The UL sweep blocks may have for example resources for initial cell access (Random Access Channel) or other periodic signals such as SR (scheduling request). There may be multiple of such sweeping sub frames defined for example per radio frame (a radio frame consist of multiple sub frames). On the sub frames which are not defined as sweeping sub frames but as e.g. data sub frames, the access point is able to control the individual beam directions more freely. This may for example be based on the scheduling decisions.

As mentioned previously, in 5G, beamforming is used to allow communication in higher frequency bands. In this application the term ‘communication beam’ refers to a beam that access point utilizes for communicating DL and UL direction with UE.

One area which is addressed by some embodiments is beam management, for example determining the best possible communication beam or set of candidate (communication) beams. This may be particularly challenging for when there is no active communication. During active communication the AP may typically receive CSI (channel state information) feedback from UE (which may be beam specific) and thus it may determine the best or a set of best beams which can be used to communicate with UE. When there is no active communication UE does not typically transmit any CSI feedback. During inactivity periods, due to the mobility of a UE, the UE and/or network may see one or more better communication beams or the current ‘selected’ beam may become unsuitable for communication so the selected beam or set of candidate beams may vary over time. The selected beam may be a beam that access point utilizes for communication or requests CSI feedback on)

Another factor is that some transceiver architectures (such as the aforementioned hybrid architecture with analogue beamforming) may have a relatively limited number of concurrent directions/beams that can be formed and used for communication.

Some embodiments may address one or more of these issues.

Some embodiments may address or mitigate the issue of how to maintain a set of candidate beams when the UE is inactive with low signalling overhead. For example an UE may be in an inactive mode such as a discontinuous reception mode DRX. Alternatively or additionally, the UE may require a low overhead beam maintenance when it is active.

For the DRX mode, in order to benefit from the energy saving gains provided by the DRX, the signalling between the UE and the AP should be minimized but the validity of a selected communication beam or a set of beams may need to be updated. A set of beams or a set of candidate beams may comprise one or more beams, for example two or more beams.

For an active UE, the network may utilize channel state information (CSI) feedback, for example, per beam which reflects the current channel state of each beam and allows the AP to have more degrees of freedom when make a scheduling decision. However, this may have a relatively high overhead for maintaining/checking the validity of set of beams, especially when the set is relatively large.

During active communication, it has been previously proposed for non beam based systems to provide CSI-feedback transmission. However in a beam based systems where there are multiple beam candidates for a UE, CSI-feedback per beam may increase signaling overhead when the beams are not in active use but are for example in a candidate set of beams that can be used to communicate with UE.

It has been proposed that in 5G that “beam mobility” inside one cell or specific set of adjacent/overlapping cluster of cells would not be visible to e.g. RRC (radio resource control) level (or it would be so in very limited manner) so managing the beams and mobility between them may be L2 (layer 2) for example, the MAC (Medium Access Control) layer.

Some embodiments may maintain a communication link between a UE and a serving AP (or a group of APs) during communication and inactivity periods in a system which uses beam forming. Some embodiments may support radio multi-connectivity. Radio multi connectivity requires at least two different access points, each access point providing one or more beams. In a single AP case, UE may have one or more beams active with one AP. A set of beams or candidate beams may comprise one or more beams.

In some embodiments, BSVI (beam set validity indication) resources and SR (scheduling request) resources are configured. In one example the SR and BSVI transmissions are dedicated single bit indications. These single bit indications may be preambles, which may be transmitted on the PUCCH (Physical Uplink Control Channel) or a similar channel. These preambles may be implemented by using e.g. so-called Zadoff-Chu sequences or the like. Alternatively the transmission resources may be configured to a UL sweep block which may have similar physical channel structure as the PUCCH channel or RACH. In one example, an access point may have separate set of preambles (a pool) reserved for SR and BSVI or it can configure the BSVI resources from the pool of SR resources. In another embodiment the BSVI may be a dedicated RACH preamble (or configured from the pool of RACH preambles). In one further example the BSVI indication can be a MAC layer message such as MAC CE (MAC control element). This MAC layer message may be used e.g. when BSVI transmission is triggered in the same sub frame as uplink data transmission.

Some embodiments allow the configuring of the triggering conditions to transmit on the configured BSVI and SR resources.

In some embodiments, the BSVI transmission may be periodic and its transmission indicates the validity of the communication link.

In some embodiments the SR transmission by the UE requests resources for further transmissions of UE.

In some embodiments, the triggering conditions for BSVI and SR transmissions may be inter-related. In other embodiments, different triggering conditions can be defined for the BSVI and SR transmissions.

In some embodiments, a control apparatus configures one or more criteria for BSVI and/or SR transmission for beam management for the UE. The criteria can be in any suitable criteria. In some embodiments there may be a set of one or more conditions. In some embodiments there may be a set of one or more triggers including relevant threshold(s). This control apparatus may be in network entity. This control apparatus may be provided in an access point or in an entity which is configured to communicate with one or more access points. In alternative embodiments the UE may configure one or more triggers. In some embodiments, the one or more triggers may be set by the UE together with the control apparatus.

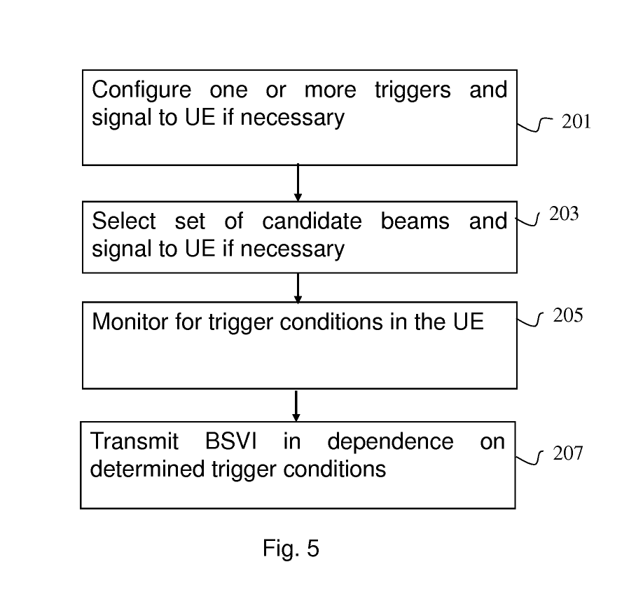

Reference is made to FIG. 5 which shows a method of an embodiment.

In step 201, one or more triggers are set. In some embodiments a set of two or more triggers is defined. In some embodiments, the one or more triggers are set by the control apparatus. The one or more triggers may be used for the triggering of one or more of the BSVI and SR. Some embodiments may only support one of the BSVI and SR. Other embodiments will support both of the BSVI and SR.

Information about the one or more triggers may be signalled to the UE, if the triggers are selected by the control apparatus.

In some embodiments, the triggers are defined and controlled by the network. In some embodiments, the UE does not set any triggers unless instructed by network. However, the triggering itself occurs at UE side. In some cases the triggers are not configured by the network but may be defined in a standard specification.

In some embodiment, there may be two or more predefined sets of one or more triggers. The control apparatus or the UE may be configured to select one of the predefined sets of one or more triggers. Where the control apparatus selects one or the predefined sets of one or more triggers, the control apparatus may be configured to transmit information to the UE indicating which predefined set of one or more triggers has been selected. Such sets may be configured by higher layers (e.g. RRC) and then indicated to UE by MAC layer signalling (or PHY (physical) layer in a DCI, (downlink control information) message)

In step 203, a set of one or more candidate beams is selected. In some embodiments, this may be done by the control apparatus. Where this is done by the control apparatus, this may be signalled to the UE.

It should be appreciated that in some embodiments, that steps 201 and 203 can be performed together or in any order. In some embodiments, step 203 may be repeated from time to time, as required.

In step 205, the UE will monitor to see if one or more trigger conditions are present.

In step 207, in response to the determined trigger condition, the UE will transmit one or more of the BSVI and the SR.

Embodiments will now be described where the control apparatus configures inter-related trigger(s) for the BSVI and SR so that when inter-related trigger conditions apply, the UE transmits the BSVI and when those conditions do not apply, the UE sends the SR.

The control apparatus may signal the set of one or more candidate beams (for example providing beam indices explicitly in a MAC CE, MAC Control Element) for the UE to monitor when in an inactive (for example DRX) or in active mode. The control apparatus, which configures the candidate set related trigger measurements (measurement configuration), may set the measurement type to be, for example, on one or more of received reference signal power levels (RSRP, reference signal received power); received reference signal quality levels (RSRQ, reference signal received quality); and RSSI (reference signal strength indicator). These may be measured from the beam specific reference signals transmitted either periodically during downlink sweep or during scheduled reference signal transmissions.

Alternatively or additionally the control apparatus may also signal the sweep block information about the candidate beams. For example as long as at least one of the signalled candidate beams is above the threshold level or all the beam levels above the level in the sweep block the UE will report BSVI.

The control apparatus may have configured a measurement filter for beam level measurement to filter any fast changes in the beam quality e.g. average over multiple measurements. The filter means that UE may for example average the measurement results over two or more measurements to avoid too early triggering. Accordingly the UE, instead of making only one measurement, it may make multiple measurements to filter out any fast changes in for example the received power level. This prevents so-called false triggering since UE has collected more data. On the other hand if the filter length is too long (e.g. UE performs too many measurements) it may take too long to react to for example beam quality causing so called late triggering. The measurement configuration may be configured by network.

One alternative way to filter out measurements is to define a so-called time to trigger (TTT) mechanism. By defining and signalling a TTT threshold and TTT timer values the control apparatus instructs UE to determine the beam quality/power level (and potential triggering thereof) by measuring if the beam quality is above the TTT threshold value for at least for the duration of TTT timer. By adjusting the length of the TTT timer UE side triggering can be controlled dynamically. Alternatively the network can instruct UE to scale the TTT timer value e.g. according to UE speed. This TTT mechanism can also be used to operate in ‘reverse manner’ so that if a beam quality is below the threshold for the duration of TTT timer the beam quality is then determined to be below threshold (which may or may not cause triggering).

These filter parameters may be e.g. determined by control apparatus and configured via the RRC and updated later e.g. in MAC level. MAC layer signalling may be used modify the initial RRC configuration or the MAC layer signalling may be used to activate different measurement configurations (which are preconfigured by RRC).

In some embodiments, as long as the trigger conditions apply, the UE transmits the BSVI according to a predetermined periodicity. When the set of trigger conditions for BSVI transmission do not apply and SR triggering is configured the SR is transmitted. When the configured SR trigger conditions have been met, the UE triggers the SR transmission and may generate for example a MAC layer beam report which is described in more detail later.

Embodiments will now be described where the control apparatus configures one or more triggers for sending the BSVI only. As long as the trigger conditions apply, the UE transmits BSVI according to predetermined periodicity. In these embodiments, when the BSVI transmission triggers do not apply, the UE does not send a SR. In these embodiments, omitting a SR transmission may apply only for beam management procedure. The SR may have other triggers such as UL data request.

Embodiments will now be described where the control apparatus configures a trigger for sending SR only. This trigger may be set for the DRX mode or the trigger may be set more generally when it applies for both active and inactive mode. The SR transmission may be triggered based on a beam quality threshold. For example if at least one of the candidate beam in a set drops below quality threshold the SR transmission may be triggered. Alternatively the SR transmission may be triggered if all the candidate beams are below the quality level.

Alternatively or additionally, the control apparatus may configure a trigger for new beams that UE detects. This may be where a new beam is detected which is outside the candidate set with a quality level above the configured threshold. When the configured trigger conditions have been met for the new beam, the UE may trigger the SR transmission and may generate a MAC layer beam report.

In some embodiments, the control apparatus may allow SR transmission during SR-prohibit timer with above trigger conditions. The SR transmission may have other triggers as well. For example, the UE requests resources for data transmission. To prevent a UE from requesting data resources too frequently a so-called prohibit timer is implemented. However the beam management is considered to be special case since it affects the connectivity with the network.

Where the SR is in response to a trigger the UE may prioritize a beam report over BSR (buffer status report) transmission on the allocated grant if both cannot fit. Alternatively a short/truncated BSR format may be used. The short and truncated BSR formats indicate the data in only one logical channel/logical channel group. A regular BSR indicates the available data in all the logical channels/logical channel groups

Some embodiments may work in parallel with a CSI-based feedback mechanism. The control apparatus may request CSI-feedback on a reduced set of beams in a candidate set (or one beam) and configure above triggers to maintain a candidate with low overhead signalling. With the parallel mode, the AP relies on UE side monitoring of the candidate set of beams. The AP may then request CSI feedback and use only one beam for communication knowing that the UE would report if other candidates drop below quality level. If this would be done only by using CSI reporting, the network would need to transmit reference signals for the UE to measure channel quality more often and/or report several beams thus increasing the feedback overhead. Some embodiments avoid the need for this. Typically CSI feedback is not trigger based unlike some of the SR and BSVI embodiments described. This is since the network needs CSI information for determining short term scheduling decisions based on instantaneous channel quality.

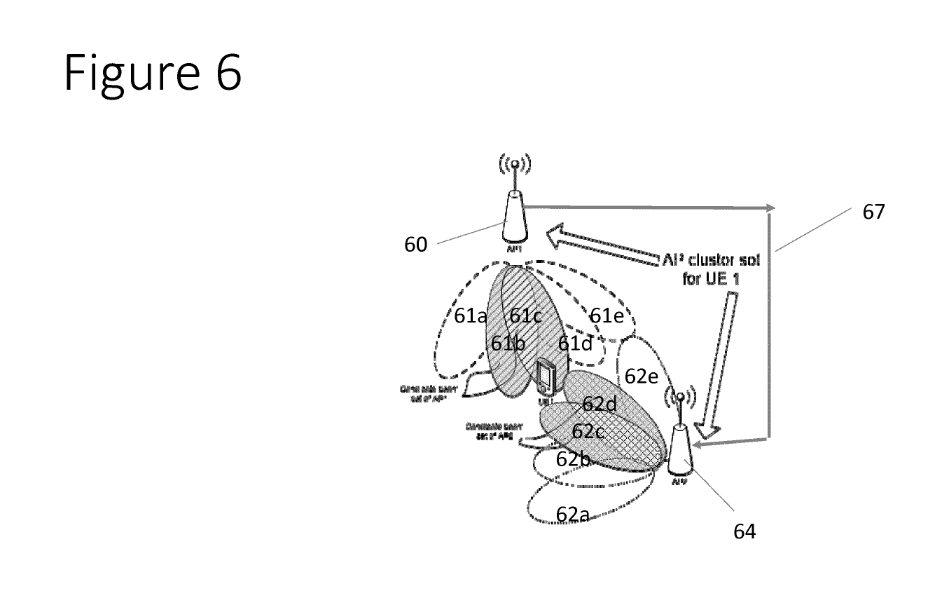

Reference is made to FIG. 6 which shows an embodiment where a UE 63 is served by candidate beams from two different access points. A first access point 60 has beams 61a, 61b, 61c, 61d, and 61e. The UE is associated with candidate beams 61b and 61c. A second access point 64 has beams 62a, 62b, 62c, 62d, and 62e. The UE is associated with candidate beams 62c and 62d. The two access points are arranged to communicate via a link 67 that is referred to as an X2 link in some standards.

The example shown in FIG. 6, the UE is associated with two different access points. These access points are referred to as a cluster set. It should be appreciated that the number of access points with which a UE is associated may be more than two. It should be appreciate that the access points may be connected via a multi-connectivity situation, a control apparatus may configure different sets of candidate beams and/or thresholds/trigger conditions per AP in an AP cluster. One way to implement this control apparatus for example in an AP cluster is to use one controlling RRC entity for two or more access points. Another way to implement the controlling entity is to one RRC entity per access point and configure one RRC entity to be a master RRC entity which may control one or more slave RRC entities.

The control apparatus may be a logical entity in an access point or in a core network. The control apparatus may be implemented e.g. in a protocol layer such as MAC layer (L2).

It should be appreciated that while the set of candidate beams may be maintained individually by the access points the threshold/triggers for managing such candidate sets (per access point) may be configured by the said control apparatus.

An access point cluster may be a set of APs configured for a UE. In one scenario the UE may indicate the validity of the beams to the first access point 60 and send (based on trigger conditions) a SR to the second access point 64.

In general, the control apparatus may configure different triggers for BSVI and SR transmissions. This may include flexible rules for selection of one or more involved AP or beams from the candidate sets to send either the BSVI or the SR or both. This may allow parallel BSVI/SR transmissions which uses the diversity of multi-connectivity MC for fast re-establishment of at least one communication link to a serving access point for a UE from the inactivity state.

Some embodiments may support the flexibility to configure the UE to select and respond to one or more of those APs which receive the BSVI and/or SR from the UE.

Alternatively or additionally having two or more sets of candidate beams and BSVI/SR triggers with different cells acts as a fall back or failsafe mechanism if a UE cannot detect the candidate beams (or the beams are low quality) of one AP, the UE may be triggered to send a SR to an adjacent cell. Thus, in some embodiments, the control apparatus may configure also an inter-cell SR trigger based on trigger values if UE has a connection to more than one access point.

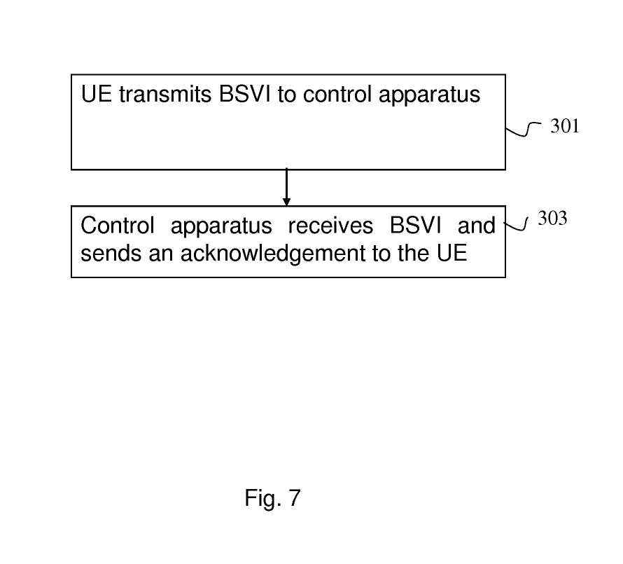

Reference is made to FIG. 7 which shows a method flow.

In step 301, the UE sends a BSVII to the control apparatus. This may be as discussed previously.

In set 303, the control apparatus receives the BSVI and is configured to provide feedback for the UEs BSVI transmission. This indicates that control apparatus has received the BSVIs and confirms that the current link is valid.

The BSVI transmission is thus acknowledged by the control apparatus. This feedback is configured to be sent in a specific time window where the time window size is smaller than BSVI periodicity.

Alternatively the window size may extend over two or more BSVI transmission periods.

The feedback provided by the control apparatus may be in any suitable and my for example be in the form of a DL side preamble sequence, a downlink control information DCI message (empty allocation), or a MAC layer feedback (e.g. a MAC CE (control element)). The BSVI and/or SI may be one bit indications.

The feedback is provided in the respective sweep field in the uplink sweep sub frame. Alternatively the feedback may be provided in an UL control symbol.

In one example when the UE does not receive NW side feedback, it may fall back to a RACH (random access channel) procedure to re-establish a connection with the AP. Alternatively in a multi-connectivity scenario, the UE may initiate a RACH procedure to an adjacent AP or send SR to adjacent AP (if SR is configured).

In one embodiment when network cannot detect a BSVI transmission by UE for example during an expected period, the network may issue for example a recovery action such as ‘cell paging’. In one example, in this cell paging, an access point would try to reach a UE by broadcasting a paging (Radio Access Network, RAN, level paging) to request a UE to re-establish connection with the access point. This may trigger RACH procedure/SR at UE side.

The control apparatus may request a beam report based on the quality of the BSVI preamble transmission. The control apparatus sends a MAC CE to request a beam report, or schedule the UE to send CSI-feedback (PDCCH order) on a specific beam index or indices. Alternatively or additionally it may schedule specific CSI-RS (Channel state reference symbol) symbols and request CSI feedback.

In one embodiment, the MAC Layer Beam (MAC CE) Report may comprise of one or more of a respective beam index and corresponding received power level/quality level measurements. For example the UE may measure beam quality levels during DL sweeps. The control apparatus configures triggers levels and filtering parameters for measurements; indication of which candidate beams are above/below a quality threshold; and other APs beams in an AP cluster set.

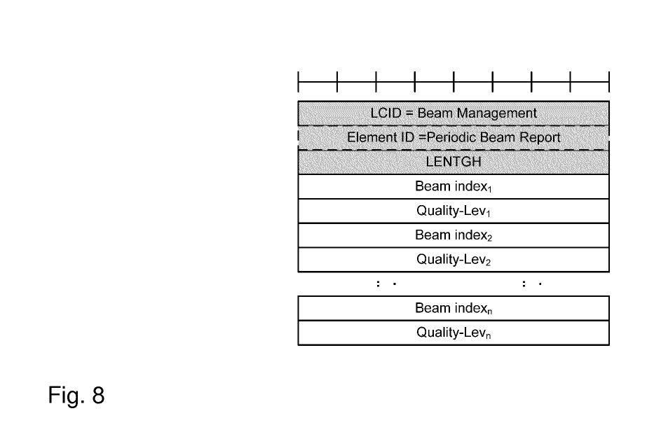

Reference is made to FIG. 8 which shows one example of a MAC layer beam report. The MAC layer beam report comprises a MAC Control Element which may include one or more of the following information:

detected beams in a serving cell above a quality level;

beam qualities in a candidate set;

beam qualities on indices requested by the AP;

beam index/indices that are above quality level; and

beam indices of adjacent cell (in a multi-connectivity set)

It should be appreciated that the beam report may comprise additional and/or alternative information.

The beam report content may vary depending e.g. whether it was requested by network or it is a periodic report. Thus there may be a plurality of formats. FIG. 8 illustrates an examples of a periodic beam report. The report has an LCID (logical channel identifier) indicating beam management, an element ID indicating a periodic beam report and length information for the report. For such format it is defined for example that a beam index is indicated by one octet and followed by one octet quality indicator. The report may contain information about x beams where x is an integer of one or more.

It should be appreciated that this only one example format. There may be further defined MAC CEs (control elements) at network side which can be used to request e.g. beam qualities of a specific set of beams (candidate set) or a report of a single beam. Such a report if it is transmitted due to predetermined trigger conditions, may include an indication of so-called cause value′ to indicate why the UE generated such report.

In some embodiments, sending the SR transmission cancels the transmission of the BSVI if the UE has transmitted beam report. This may be applicable to the single AP case.

In some embodiments, a RACH (random access channel) fall back procedure is triggered if the UE has no UL grant after transmitting N scheduling requests, where N is an integer. N may be configurable by the network. In some embodiments, N may be 2 or 3. It should be appreciated that this is by way of example only and in other embodiments N may be 1 or more than 3.

In some embodiments, the UE DRX cycle may be aligned with sweeping sub frames per access point. The DRX ON time may be aligned with downlink sweeping sub frames or alternatively selected sweeping blocks (one block is one or more symbols). During DRX OFF time, the UE may transmit on the assigned UL resources but is not expected to monitor a control channel such as the physical downlink control channel PDCCH.

In some embodiments, BSVI and SR resources are preamble sequences configured to an UL sweeping block, across all the sweeping blocks, or the indication can be a MAC CE.

BSVI and SR resources may be RRC configured, but can be modified by e.g. MAC level signalling. Depending on the beam indices indicated by the control apparatus, it may also provide an implicit indication on which UL sweeping blocks a UE sends the BSVI and/or SR.

The BSVI may be allocated an own MAC CE (e.g. logical channel identifier LCID) which can be used when the UE has a valid UL grant. The control apparatus may configure a prohibit timer during which the UE shall not indicate the BSVI. The timer may apply to both preamble and MAC CE based BSVIs, or only for MAC CE based BSVI. Regardless of the BSVI prohibit timer, the UE may indicate the SR (or the beam report if UE has a valid UL grant) if some of the triggers apply.

In some embodiments, the candidate beam set is determined for the DRX/active state. The UE may enter DRX state based on a DRX command and/or in dependence on a DRX inactivity timer.

Where the UE enters the DRX mode in response to a DRX command from the access point, the access point may indicate the set of candidate beams (or a beam) in an extended DRX command (beam indices). Alternatively during an active state, the access point may send a MAC CE to indicate explicitly the candidate beam set.

In the case where the UE enters DRX in response to an inactivity timer or is in active state, the control apparatus has a preconfigured threshold level for beam validity. The UE utilizes the last beam index that it sent CSI feedback for and/or the beam indices of the current sweep block it heard (if SR is sweep block specific).

The control apparatus may configure the BSVI and/or SR triggers transmission for Short DRX/Long DRX and/or active state. For example the BSVI is activated for the short DRX but not for the long DRX.

In some embodiments, the one or more triggers may be valid in both active and DRX modes. In some embodiments, the triggers may only be valid for one of the active and inactive modes. In some embodiments, different triggers may be provided for both the active and DRX modes.

In some embodiments, the triggers for a set of beams or candidate beams may be the same. This may have the advantage of simplicity. However, in alternatively embodiments, triggers may be set on a per beam or subset of beams basis.

In some embodiments, in a multi-connectivity case these trigger levels may be cell specific.

Triggers may be different for different events. For example the quality level trigger for reporting a bad quality beam can be different to a quality level trigger for determining whether a new beam is to be reported.

The required data processing apparatus and functions of a network elements such as base station apparatus and other access points and controller elements, a communication device, a core network element and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method comprising:
determining at a communication device for a set of beams provided by one or more access points if a respective beam satisfies a criteria, wherein said set of beams comprises one or more communication beams and each access point provides a plurality of communication beams; and
in dependence on said determining, causing an indication to be transmitted to at least one access point.

2. A method as claimed in claim 1, wherein at least two of said beams in said set have a respective different criteria.

3. A method as claimed in claim 1, comprising receiving information on the or each criteria from the or respective access point.

4. A method as claimed in claim 1, wherein said determining is performed when said communication device is in a discontinuous reception mode.

5. A method as claimed in claim 1, wherein said indication comprises a single indication for said set of beams.

6. A method as claimed in claim 1, wherein said indication comprises a single bit.

7. A method as claimed in claim 1, wherein said indication comprises an indication indicating that at least one of said beams of said set satisfies a respective criteria.

8. A method as claimed in claim 1, wherein said indication comprises an indication indicating that all of said beams of said set satisfy a respective criteria.

9. A method as claimed in claim 1, wherein said causing of said indication to be transmitted is carried out with a defined periodicity.

10. A method as claimed in claim 1, wherein when, in dependence on said determining that said indication is not be transmitted, causing a scheduling request to be transmitted to at least one access point.

11. A method as claimed in claim 10, comprising only causing said scheduling request to be transmitted if at least one condition is satisfied.

12. A method as claimed in claim 11, wherein said at least one condition is related to said at least one criteria.

13. A method as claimed in claim 1, wherein said indication comprises a scheduling request.

14. A method as claimed in claim 1, wherein said indication is transmitted in an uplink sweep block, and wherein said indication is transmitted in an uplink control symbol.

15. (canceled)

16. A method as claimed in claim 1, comprising, after causing said transmission of said indication, receiving a request from an access point for information on one or more beams and in response thereto, providing said requested information on said one or more beams.

17. A method comprising:
providing a plurality of communication beams, one or more of said communication beams being a set for communication with a communication device; and
receiving an indication from said communication device, said indication being dependent on whether if a respective beam satisfies a criteria at the communication device.

18. A non-transitory computer-readable storage medium comprising instructions stored thereon that, when executed by at least one processor, are configured to cause a computing system to perform the method of claim 17.

19. An apparatus in a communication device comprising at least one processor and at least one memory including computer code for one or more programs, the at least one memory and the computer code configured, with the at least one processor, to cause the apparatus at least to:
determine at a communication device for a set of beams provided by one or more access points if a respective beam satisfies a criteria, wherein said set of beams comprises one or more communication beams and each access point provides a plurality of communication beams; and
in dependence on said determining, cause an indication to be transmitted to at least one access point.

20. An apparatus as claimed in claim 19, wherein said indication comprises a single indication for said set of beams.

21. (canceled)

22. A non-transitory computer-readable storage medium comprising instructions stored thereon that, when executed by at least one processor, are configured to cause a computing system to perform the method of claim 1.
